(19) United States
(12) Patent Application Publication
(10) Pub. No.: US 2013/0297465 A1
(43) Pub. Date: Nov. 7, 2013

(54) SOFTWARE AND METHOD FOR SELLING PRODUCTS

(71) Applicant: James Plankey, Arlington Heights, IL (US)

(72) Inventor: James Plankey, Arlington Heights, IL (US)

(21) Appl. No.: 13/858,730

(22) Filed: Apr. 8, 2013

Related U.S. Application Data
(60) Provisional application No. 61/641,737, filed on May 2, 2012.

(51) Int. Cl. G06Q 10/08

(52) U.S. Cl. CPC G06Q 10/087
USPC 705/28

(57) ABSTRACT

A system of uploading information and selling a product from a web-based media portal. The system may include a computer program that enables a user to upload product information and record video of the product. The computer program further allows the user to extract still photos from the video and to upload the product information, recorded video, and extracted still photos to a web-based media portal to be accessed and displayed to a third-party consumer.

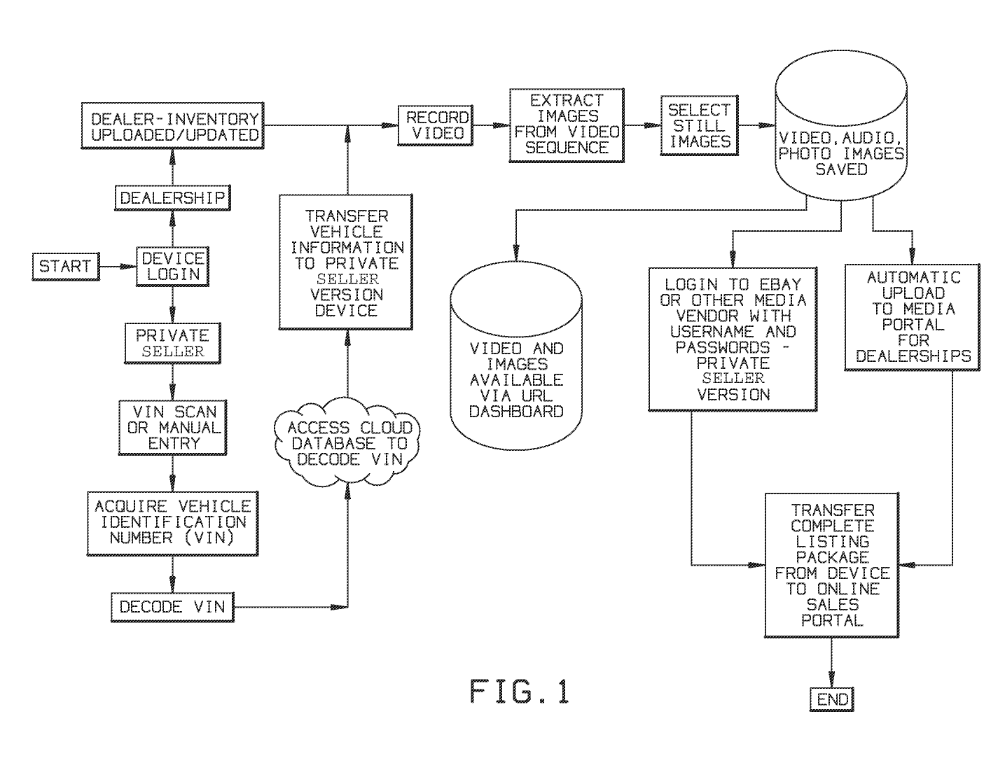

### BACKGROUND OF THE INVENTION

The present invention relates to a software and method for selling products and, more particularly, to a software that enables a user to upload and display information, videos, and pictures on a web-based media portal.

The problem with marketing a product on different web portals including a website, such as eBay®, Craig's list®, cars.com®, etc., is that it requires multiple logins, which may be time consuming and tedious. For dealerships, the industry standard is to take photos first, and then the photos may be processed through an elaborate PowerPoint styled stitching and called a video. Further, photos and video must be shot on multiple devices, including a camera, video camera, or a smart phone, then the photos, and videos need to be uploaded to a desktop, or laptop computer. From the computer, photos, and video can be uploaded to an appropriate web vendor. For the private seller, media can be loaded, but only one vendor at a time. The current process is time consuming and requires a user to take multiple steps. Further, the current process limits a private seller to upload the content to one web vendor at a time and video, photos and audio may be limited or missing altogether.

As can be seen, there is a need for easily uploading of information to a web-based media portal.

### SUMMARY OF THE INVENTION

In one aspect of the present invention, a system for online selling of a product, comprises: a computer having a user interface; and a program product comprising computer-readable program code for causing, when executed, the computer to perform the following process steps: downloading information about the product to be sold, wherein the information is inputted from a user; recoding video, wherein the user records video of the product to be sold; saving the recorded video to a database or an internal memory of the computer; extracting still images from the video, wherein the user extracts the still images; saving the still images to a database or the internal memory of the computer; and uploading the information about the product to be sold, the video and the still images to a media portal to be accessed by a third party and displayed to the third party.

These and other features, aspects and advantages of the present invention will become better understood with reference to the following drawings, description and claims.

### BRIEF DESCRIPTION OF THE DRAWINGS

The FIGURE is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system of uploading information and selling a product from a web-based media portal. The system may include a computer program that enables a user to upload product information and record video of the product. The computer program further allows the user to extract still photos from the video and to upload the product information, recorded video, and extracted still photos to a web-based media portal to be accessed and displayed to a third-party consumer.

The present invention provides a system for simplifying the ability to market a product with video, photo, and audio media through web vendors. The present invention allows a user to take video, record audio, and extract photos to upload a complete marketing package to one or more web vendors with one device.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

Referring to the FIGURE, the present invention may include a system for uploading information and selling products. As illustrated in the FIGURE, the system may be used for selling cars. However, the present invention is not limited to selling cars and may be used for selling a wide variety of products. In certain embodiments, the present invention may begin with either a private seller or a dealer logging into the software on a user interface of a computer. For a dealer, the dealer may upload or update their inventory to the program product. If selling a car, the private seller may scan a Vehicle Identification Number (VIN) or manually enter the VIN into the program. The program may acquire the VIN number, and decode the VIN by accessing a cloud database for decoding. The information of the car may thereby be transferred back to the private seller's computer device.

Once these steps have been completed, a video of the product may be recorded and uploaded to the software. Still images may be extracted from the video and selected by the user. The video, audio and still images may be saved to the program product. In certain embodiments, the video and images may be presented and available to consumers via a URL dashboard, such as on a website. The URL dashboard may also be available to the dealer for uploading and editing of the information. For a private seller, the user may login to a media vendor, such as E-bay®, cars.com® and the like, and transfer the complete listing package from the device to the online sales portal. For a dealer, the video, audio and images may be automatically uploaded to a media portal for the dealer, which transfers the complete listing package from the device to the online sales portal.

By following the outlined steps, a user may now have an easy simplified process to market their goods. The current system allows a user the ability to shoot video with AOV/AV, AOV/AV2 applications, such as—AOV (Autos On Video) AV2 or AW AV Square (Autos Via Video—Private Seller) and SW (Sell Via Video) that is loaded on user's device. The user records the video, and from the video, still images may be extracted. The user may then select one, or multiple vendors, and download vehicle photos, videos, and complete marketing package from one device.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for online selling of a product, comprising:
a computer having a user interface; and
a program product comprising computer-readable program code for causing, when executed, the computer to perform the following process steps:
downloading information about the product to be sold, wherein the information is inputted from a user;
recoding video, wherein the user records video of the product to be sold;
saving the recorded video to a database or an internal memory of the computer;
extracting still images from the video, wherein the user extracts the still images;
saving the still images to a database or the internal memory of the computer; and
uploading the information about the product to be sold, the video and the still images to a media portal.

2. The system of claim 1, wherein the video comprises audio and video.

3. The system of claim 1, wherein the extraction of the still images is at least one of an automated extraction and a manual extraction.

4. The system of claim 1, wherein the media portal is accessed and displayed to a third party on the internet.

5. The system of claim 1, wherein the user is a private seller.

6. The system of claim 3, wherein the product is a vehicle.

7. The system of claim 4, wherein the information inputted from the private seller is a Vehicle Identification Number.

8. The system of claim 5, wherein the program product further causes the computer to decode the Vehicle Information Number and save the decoded Vehicle Information Number to the computer.

9. The system of claim 1, wherein the video and the still images are available via a URL dashboard.
